(19) United States
(12) Patent Application Publication
(10) Pub. No.: US 2008/0205216 A1
(43) Pub. Date: Aug. 28, 2008

(54) INFORMATION RECORDING APPARATUS CAPABLE OF RECORDING INFORMATION IN INFORMATION RECORDING MEDIUM, INFORMATION RECORDING METHOD, AND TARGET VALUE DETERMINING METHOD

(75) Inventors: AKIHITO OGAWA, Yokohama-shi (JP); Hideo Ando, Hino-shi (JP); Hideaki Ohsawa, Yokohama-shi (JP); Kazuo Watabe, Yokohama-shi (JP); Kazuto Kuroda, Yokohama-shi (JP); Chosaku Noda, Yokohama-shi (JP); Naoki Morishita, Yokohama-shi (JP); Nobuaki Kaji, Yokohama-shi (JP); Takehiro Hiramatsu, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/039,723

(22) Filed: Feb. 28, 2008

(30) Foreign Application Priority Data
Feb. 28, 2007 (JP) 2007-050310

(51) Int. Cl. G11B 7/0037

(52) U.S. Cl. 369/47.28

(57) ABSTRACT

According to one embodiment, an apparatus which records a signal in a recording medium in which information is written by using a first laser having a first wavelength and from which information is read by using a second laser having a second wavelength longer than that of the first laser, a signal is recorded in the recording medium by using the first laser, and a control section reproduces the signal recorded with the first laser and measures a first amount that is used to calculate a target value for optimization of recording conditions, reproduces a signal recorded with the second laser and measures a second amount for optimization of a reproduction signal, compares the first amount with the second amount, and determines the first amount under the recording conditions where the second amount becomes optimum as a target value for optimization of the recording conditions.

### CROSS-REFERENCE TO RELATED APPLICATIONS

This application is based upon and claims the benefit of priority from Japanese Patent Application No. 2007-050310, filed Feb. 28, 2007, the entire contents of which are incorporated herein by reference.

### BACKGROUND

1. Field

One embodiment of the invention relates to a recordable information recording medium, an information recording apparatus that can record information in the information recording medium, an information recording method, a target value determining method, and an information recording condition optimizing method.

2. Description of the Related Art

In a currently commercially available DVD-R disc or a DVD-RW disc as a recording type optical disc, address information is previously recorded by using a land pre-pit, and a recording mark is formed on a wobbled pre-groove.

A reproduction signal from the land pre-pit or the pre-groove is utilized to reproduce the address information or used as a tracking servo signal. In order to perform stable tracking or accurately reproduce the address information, a shape of the land pre-pit or the pre-groove is optimized to provide the reproduction signal for such an operation as a large signal.

Further, in a current optical disc apparatus, a technique of optimizing recording conditions, e.g., a recording power or a recording pulse width is also used to realize more stable information recording.

Japanese Patent Application Publication (KOKAI) No. 2004-192679 is explained an example of a method of calculating an optimum recording power when recording information, i.e., optimization of recording conditions based on a detection value of an optical phase difference of an optical disc.

However, in a read-only DVD-ROM disc, address information or a track is formed by using a recording mark formed as an embossed pit, and the land pre-pit or the pre-groove is not formed. Therefore, the read-only optical disc apparatus is optimized to reproduce information in the recording mark, and mixing a reproduction signal of the land pre-pit or the pre-groove inherent to the recording type optical disc into this apparatus results in a noise component. In this case, even if a recording mark having optimized recording conditions is used, reproduction characteristics are degraded.

As a result, even in case of a read-only or recording/reproduction optical disc apparatus is used, when the recording mark is reproduced, a reproduction signal of the land pre-pit or the pre-groove likewise serves as noise.

As explained above, the current disc such as a DVD-R or DVD-RW disc has a problem that recording mark reading characteristics are degraded as compared with a read-only optical disc (a DVD-ROM).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a cross-sectional structure of a recording region in a recording medium according to an embodiment of the invention;

FIG. 2 is an exemplary diagram showing an example of a cross-sectional structure of a recording region in a recording medium according to an embodiment of the invention;

FIGS. 3A to 3C are exemplary diagrams, each showing an example of a relationship between a pre-groove dimension and a land pre-pit dimension of the recording medium of FIGS. 1 and 2 and a wavelength of recording light according to an embodiment of the invention;

FIG. 4 is an exemplary diagram showing an example of a layout of an information recording layer in the recording medium of FIGS. 1 and 2 according to an embodiment of the invention;

FIG. 5 is an exemplary diagram showing an example of a structure of a lead-in region of the recording medium of FIG. 4 according to an embodiment of the invention;

FIG. 6 is an exemplary diagram showing an example of information recorded in a lead-in region of the recording medium of FIG. 4 according to an embodiment of the invention;

FIGS. 7A and 7B are exemplary diagrams, each showing an example of information recorded in a lead-in region of the recording medium of FIG. 4 according to an embodiment of the invention;

FIG. 8 is an exemplary diagram showing an example of a function block of an optical disc apparatus according to an embodiment of the invention;

FIG. 9 is an exemplary diagram showing an example of a function block of an optical disc apparatus according to an embodiment of the invention;

FIGS. 10A and 10B are exemplary diagrams, each showing an example of a waveform of a reproduction signal from a recording medium according to an embodiment of the invention;

FIGS. 11A and 11B are exemplary diagrams, each showing an example of a waveform of a reproduction signal from a recording medium according to an embodiment of the invention;

FIGS. 12A to 12D are exemplary diagrams, each showing an example of recording information in a recording medium and a shape of a recording waveform according to an embodiment of the invention;

FIG. 13 is a flowchart showing an example of a method of determining recording waveform setting information on a recording for the recording medium according to an embodiment of the invention;

FIG. 14 is an exemplary diagram showing an example of signal grade information (an error rate/jitter) defined based on a reproduction result of test data using a process shown in FIG. 13;

FIG. 15 is a flowchart showing an example of a technique of determining a target value for OPC for the recording medium of FIGS. 1 and 2 according to an embodiment of the invention;

FIG. 16 is a flowchart showing an example of a technique of determining a target value for OPC for the recording medium of FIGS. 1 and 2 according to an embodiment of the invention;

FIG. 17 is an exemplary diagram showing an example of signal grade information (asymmetry) defined based on a reproduction result of test data with the process of the flowchart of FIG. 15 or 16, according to an embodiment of the invention;

FIGS. 18A and 18B are exemplary diagrams, each showing an example of signal grade information (a modulation degree/modulation degree (amplitude) variation) defined based on the reproduction result of test data with the process of the flowchart of FIG. 15 or 16, according to an embodiment of the invention;

FIG. 19 is a flowchart showing an example of recoding a recording medium of the embodiment using an optical disc apparatus according to an embodiment of the invention;

FIG. 20 is a flowchart showing an example of a technique of determining a target value for OPC for the recording medium of FIG. 1 or 2 (when the disc drive apparatus is for both recording and reproduction) according to an embodiment of the invention;

FIG. 21 is an exemplary diagram explaining an example of a technique of determining a target value for Running Optimum Power Control (ROPC) used together with OPC shown in FIG. 20 according to an embodiment of the invention; and

FIG. 22 is a flowchart showing (another) example of a technique of determining a target value for OPC shown in FIG. 20 (when the disc drive apparatus is dedicated to recording) according to an embodiment of the invention.

### DETAILED DESCRIPTION

Various embodiments according to the invention will be described hereinafter with reference to the accompanying drawings. In general, according to one embodiment of the invention, an apparatus which records a signal in an information recording medium in which information is written by using a first laser beam having a first wavelength and from which information is read by using a second laser beam having a second wavelength longer than that of the first laser beam, a signal is recorded in the information recording medium by using the first laser beam, and a control section reproduces the signal recorded with the first laser beam and measures a first evaluation amount that is used to calculate a target value for optimization of recording conditions, reproduces a signal recorded with the second laser beam and measures a second evaluation amount for optimization of a reproduction signal, compares the first evaluation amount with the second evaluation amount, and determines the first evaluation amount under the recording conditions where the second evaluation amount becomes optimum as a target value for optimization of the recording conditions.

Embodiments of this invention will be described in detail with reference to the drawings.

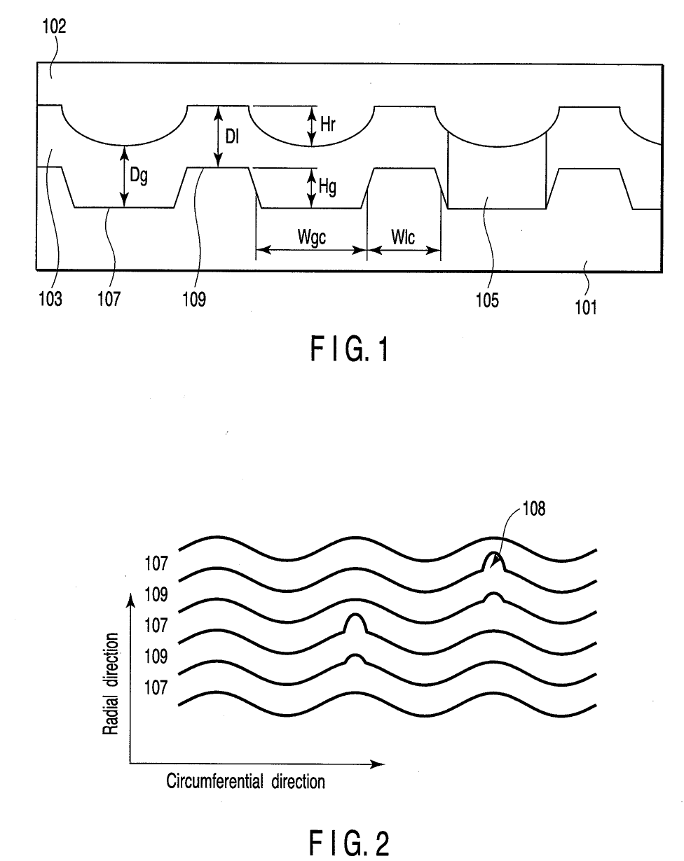

FIGS. 1 and 2 show a fine structure in an information recording medium according to this embodiment. FIG. 1 is a cross-sectional view of an information recording medium, and FIG. 2 is a view showing a groove arrangement of the information recording medium from above. In FIG. 1, each land pre-pit 108 depicted in FIG. 2 is omitted.

An organic-dye-based material is used as a material of a recording layer 103 in a write-once information recording medium in this embodiment, and an optical recording layer 102 made of an inorganic material, e.g., Ag or an Ag alloy is formed to be adjacent to the recording layer 103.

On an interface between the recording layer 103 and the optical reflection layer 102, an irregular shape having steps Hr is formed in a pre-groove 107 or a land pre-pit 108 portion. Although the irregular shape is also present on an interface of the optical reflection layer 102 on an opposite side, FIG. 1 shows a view taken along the center of the optical reflection layer 102 since a thickness of the optical reflection layer 102 is sufficiently large, and the irregular shape on the interface on the opposite side is omitted in this drawing.

Although an example where an organic-dye-based material is used as the recording layer 103 in the write-once information recording medium in this embodiment will be explained below, the present invention is not restricted thereto, and an inorganic material may be used as a material of the recording layer 103. As an example where an inorganic material is used as a material of the recording layer 103, a phase change type (a phase change is utilized to form a recording mark 105) recording material, e.g., a chalcogenide-based material can be used, or a hole may be directly formed to produce each recording mark 105 like Te—C or a plurality of different inorganic layers may be laminated and a mixture or a compound may be formed in the recording mark 105 based on diffusion using heat.

In a recording medium as an embodiment according to the present invention, light having a wavelength shorter than 650 nm as a first wavelength is used to record information, and light having a wavelength of 650 nm as a second wavelength is used to reproduce the recorded information. Therefore, as a material of the recording layer, one having a high absorption factor with respect to light having a wavelength shorter than 650 nm is desirable so that recording is enabled with light having a wavelength shorter than 650 nm. Furthermore, a material whose refractive index or reflectivity greatly changes with respect to a wavelength near 650 nm before and after recording is desirable so that recorded data can be reproduced with 650 nm.

The pre-groove 107 is concentrically or spirally formed in a substrate 101 of the information recording medium, and the pre-groove 107 meanders in a radial direction as shown in FIG. 2. This meandering shape is called a wobble. Moreover, a shape that the pre-groove protrudes is formed at a part of the land, and this is called the land pre-pit 108.

In case of the information recording medium according to this embodiment having the cross-sectional structure depicted in FIG. 1, a track deviation detection signal using a push-pull method or a detection signal from the land pre-pit 108 can be obtained based on diffraction/interference of light reflected on the interface between the recording layer 103 and the light reflection layer 102 having each step Hr.

Characteristics of the structure of the information recording medium according to the present invention will now be explained.

In the embodiment according to the present invention, the recording/reproducing apparatus is significantly characterized in that a usable wavelength of recording light is different from that of reproducing light and an information recording medium that guarantees excellent recording characteristics and reproduction characteristics with respect to the recording light and the reproducing light having different wavelengths is provided. Additionally, the recording/reproducing apparatus is also characterized in that a shape and a dimension of the pre-groove and a shape and a dimension of the land pre-pit are set so that a track deviation detection signal and a land pre-pit detection signal can be obtained with respect to the recording light and the reproducing light is hardly affected by the pre-groove or the pre-pit. In the current DVD-R disc or DVD-RW disc, a value of 650±5 nm is premised as a wavelength of the reproducing light.

In the information recording medium according to this embodiment, information can be reproduced by using light having a wavelength of 650±5 nm to assure mutual compatibility between the DVD-R disc or the DVD-RW disc.

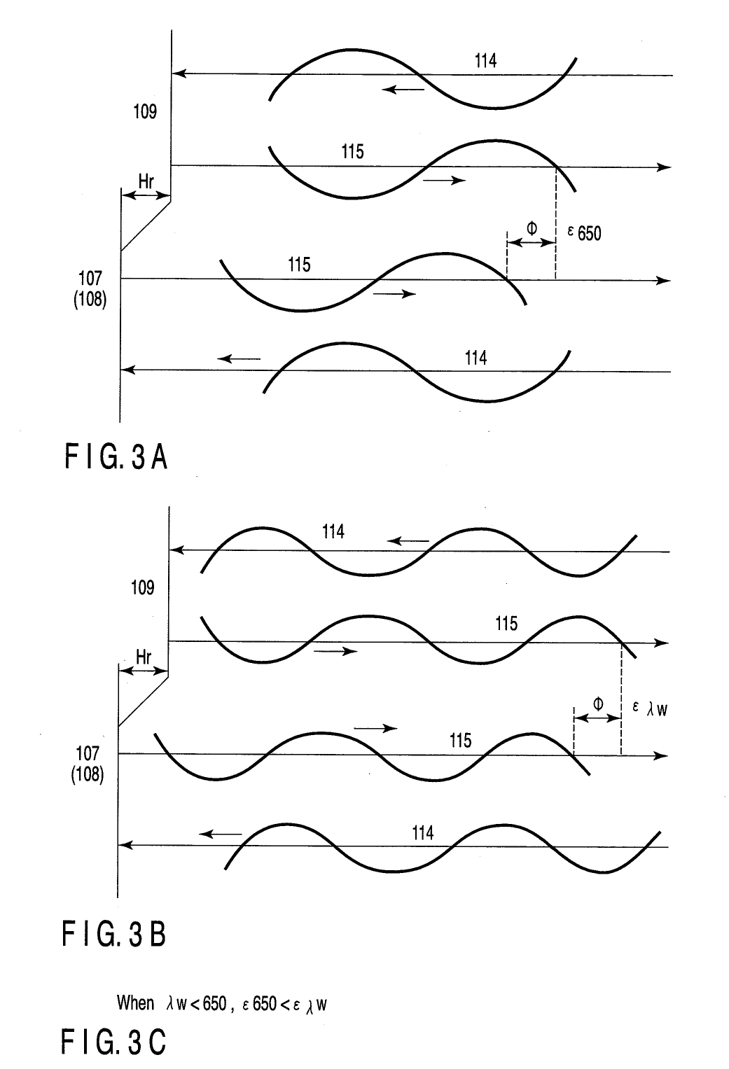

A relationship between a wavelength of the recording light and both a pre-groove dimension and a land pre-pit dimension that enable obtaining a track deviation detection signal and a land pre-pit detection signal with respect to the recording light and prevent the reproducing light (light having a wavelength of 650±5 nm) from being hardly affected by the pre-groove or the pre-pit will now be explained with reference to FIG. 3.

As explained above, the track deviation detection signal using the push-pull method or the detection signal from the land pre-pit 108 is obtained based on diffraction/interference of light reflected on the interface between the recording layer 103 and the light reflection layer 102 (see FIG. 2). A situation where incident lights 114 having different wavelengths enter the pre-groove 107 having the steps Hr or both the land pre-pit 108 and the land 109 will be explained.

FIG. 3A shows an example where reproducing light having a wavelength of 650 nm is applied, and ε₆₅₀ denotes a phase difference given to reflected light 115 vertically reflected with respect to the pre-groove 107 or the land pre-pit 108 and the land 109 by each step Hr.

FIG. 3B shows an example where recording light having a wavelength λw different from that of the reproducing light is applied. ε_{λw} is a phase difference given to the reflected light 115 obtained from the recording light by the step Hr.

As shown in FIG. 3C, if amounts of the respective steps Hr are equal to each other, a relationship of ε₆₅₀<ε_{λw} is achieved when λw<650 nm.

If ε₆₅₀<π and ε_{λw}<π, an amount of interference between the reflected lights 115 is increased when the phase difference ε is large, and the large track deviation detection signal and the large land pre-pit detection signal can be obtained. Further, the interference between the reflected lights 115 is reduced when the phase difference ε is small, and an adverse impact hardly occurs from the pre-groove or the pre-pit. Therefore, this embodiment is significantly characterized in that the wavelength λw of the recording light is shortened (λw<650 nm) with respect to the wavelength (650±5 nm) of the reproducing light so that the track deviation detection signal and the land pre-pit detection signal can be obtained with respect to the recording light and the reproducing light is hardly affected by the pre-groove or the pre-pit.

As a value of the wavelength λw used for the recording light, an arbitrary value can be taken as long as it is smaller than 650 nm. However, since a semiconductor laser beam source having an emission wavelength of 405 nm is used in an HD DVD or a Blu-ray disc (BD), likewise using a beam source with an emission wavelength of 405 nm enables producing a recording optical head at a low cost.

Here, assuming that n₆₅₀ is a refractive index in the recording layer 103 with respect to the reproducing light having 650±5 nm as the second wavelength, the largest land pre-pit detection signal and track deviation detection signal can be detected when a depth (the step) Hr of the pre-groove equal to a depth (the step) of the land pre-pit is “650/(8·n₆₅₀) nm”. Therefore, in this embodiment, as conditions avoiding an adverse impact at the time of reproduction, each of the depth (the step) of the pre-groove and the depth (the step) Hr of the land pre-pit is set to a half value, i.e., “650/(16·n₆₅₀) nm” or below. Furthermore, as conditions further avoiding the adverse impact, it is desirable to set it to a value that is ½ of the above value, i.e., “650/(32·n₆₅₀) nm” or below.

Here, assuming that the wavelength of the recording light having the first wavelength is 405 nm, each of the depth (the step) of the pre-groove and the depth (the step) Hr of the land pre-pit during recording is “405/(10·n₄₀₅) nm (=650/405×405/(16·n₆₅₀) nm)”, and signals from the pre-groove and the land pre-pit can be reproduced during recording.

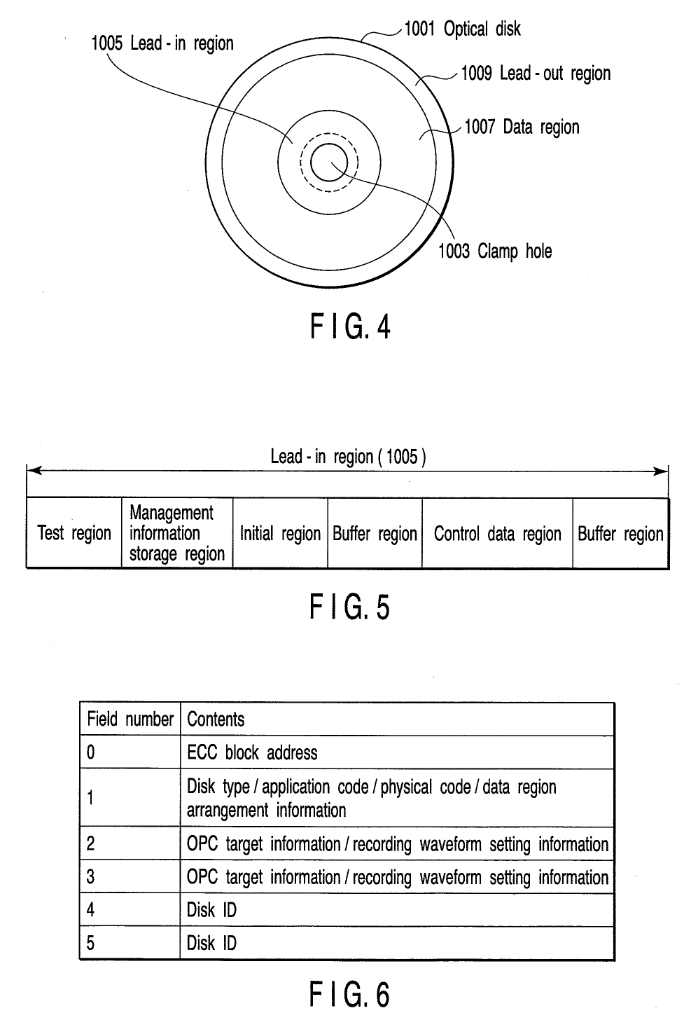

FIG. 4 shows a layout of an information recording layer in an information recording medium, i.e., an optical disc according to an embodiment of the present invention.

An optical disc D (1001) has a catching clamp hole 1003 at the center, an information recording layer (having no reference numeral) has such a structure as shown in FIGS. 1 and 2, and this layer is divided into a lead-in region 1005, a data region 1007, and a lead-out region 1009 from an inner peripheral side. Of these regions, content information like picture information is recorded in the data region 1007. Moreover, dummy data that allows overrun of a servo is recorded in the lead-out region 1009.

FIG. 5 shows a structure of the lead-in region.

In the lead-in region 1005 are arranged a test region, a management information storage region, an initial region, a buffer region, a control data region, and a buffer region from the inner periphery.

The test region is a region that is used for optimum power control (OPC) over a recording waveform by an optical disc apparatus. The management information storage region is a region in which information, e.g., a position of an optimized recording waveform or a position where recording is currently performed, a current state of the disc (an unrecorded state, a currently recording state, an ROM compatible state), and others is sequentially recorded when recording information in the data region 1007.

Dummy data that allows overrun of the servo is recorded in both the initial region and the buffer region. Information, e.g., later-explained physical format information is formed in the control data region in the form of the pre-pit or the recording mark.

The pre-groove (“107” in FIGS. 1 and 2) wobbled with a predetermined amplitude and cycle and the land pre-pit (“108” in FIG. 2) are formed in each of the lead-in region 1005, the data region 1007, and the lead-out region 1009.

FIG. 6 shows format information recorded in the lead-in information “1005” in FIG. 4) by using the land pre-pit (“108” in FIG. 2).

As apparent from FIG. 6, the information recorded by using the land pre-pit is divided into six fields 0 to 5.

Address information in units of ECC blocks is recorded in the field 0. A disc type, an application code, a physical code, and data region arrangement information are recorded in the field 1. OPC target information and recording waveform setting information when using the first wavelength according to an embodiment of the present invention are stored in the fields 2 and 3. A disc identification number (ID) is recorded in the fields 4 and 5.

The disc type is formed of, e.g., a type (read-only [ROM]/rewritable [-RW]/write-once [-R]) information of a written standard that the disc conforms to and version number information.

A purpose of use of the disc is recorded in the application code. For example, this information is indicative of whether the disc is a disc that records general data, whether the disc is a disc used for manufacturing on demand (MOD), or whether the disc is a disc that is used for electronic sell-through (EST). Here, MOD is a conformation that encrypted picture contents and the like are distributed to a service anchor through, e.g., a network, the contents are recorded in the information recording medium by the optical disc apparatus installed in the service anchor, and this information recording medium is sold. Additionally, EST is a conformation that encrypted picture contents and the like are directly distributed and sold to an end user and the contents are allowed to be recorded in the information recording medium of the end user by the optical disc apparatus owned by the end user. The optical disc apparatus can readily judge whether the inserted disc is a general data recording disc or an EST disc by confirming the disc type or the application code and also judge whether the disc is a recording medium that is allowed to select an optimum recording wavelength or record the distributed contents.

Information indicative of a physical shape and characteristics of the recording medium is recorded in the physical code. This is information indicative of, e.g., a diameter of the disc, each interval between recording tracks, a type of the recording medium, a recommended recording rate, a wavelength of a laser beam used for recording, a wavelength of a laser beam used for reproduction, and others. A range in the disc where data can be recorded is stored as, e.g., a physical address in the data region arrangement information.

An OPC target value used for recording waveform optimum power control (OPC) of a recording laser that is utilized to record information in the optical disc (the recording medium) by the optical disc apparatus according to an embodiment of the present invention is stored in the OPC target information according to an embodiment of the present invention. The OPC target value is determined and stored in the following procedure.

The optical disc apparatus makes reference to this OPC target value before or during recording user information in the disc to adjust optimization of the recording waveform, thereby recording information under conditions optimum for each disc and improving stability of user information recording and compatibility between apparatuses.

Shape information of the recording waveform optimized based on the first waveform used to carry out recording is stored in the recording waveform setting information when using the first waveform according to an embodiment of the present invention. This shape information is determined and stored based on a later-explained procedure.

The optical disc apparatus makes reference to the recording waveform setting information before recording the user information in the disc to adjust optimization of the recording waveform, thereby recording the information under conditions optimum for each disc and improving stability of user information recording and compatibility between apparatuses.

An identification number distinguished from others based on, e.g., a disc manufacturer's name, a type of the disc, a recording rate, or a serial number is stored in the form of an ASCII code in the disc ID (the identification number).

Further, although such information is recorded by using the land pre-pit in this explanation, the same effect can be obtained when, e.g., a wobble signal is modulated in a modulation mode, e.g., phase modulation.

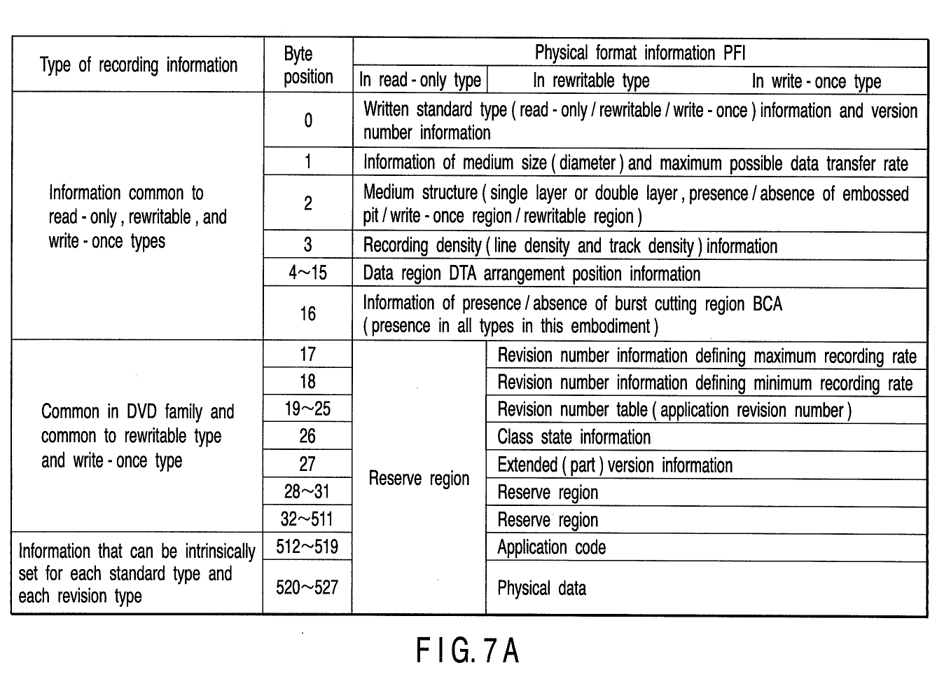

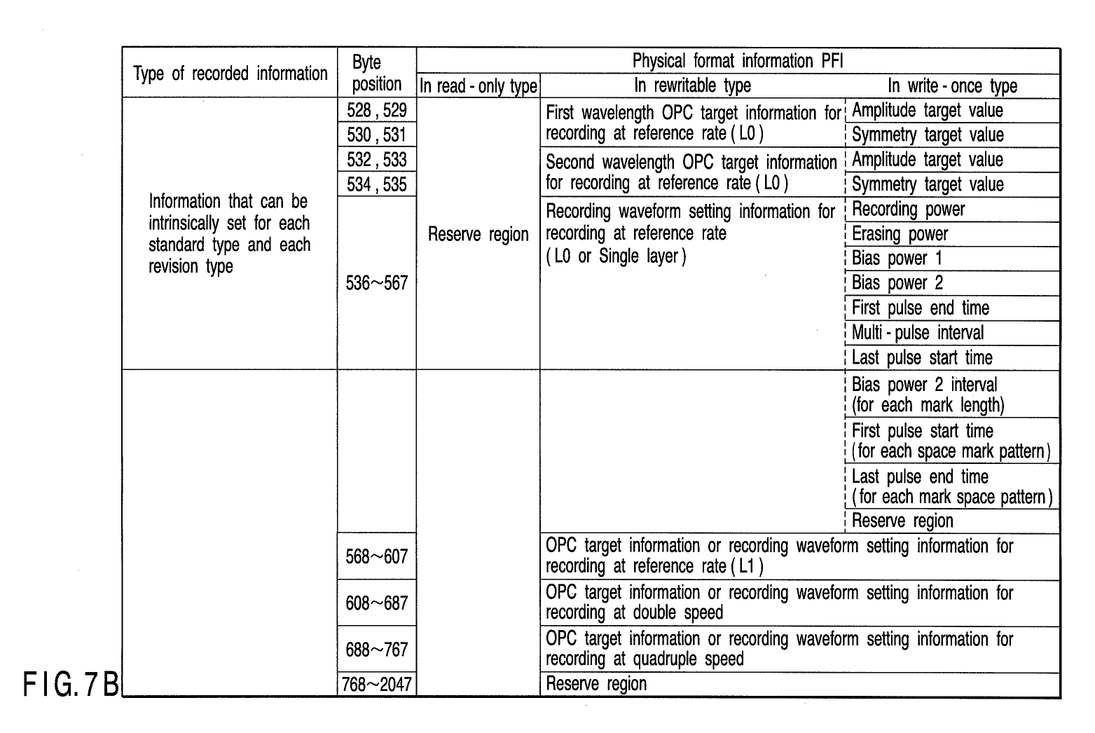

FIGS. 7A and 7B show physical format information recorded in the control data region by using an embossed pit or a recording mark.

In the information recording medium according to an embodiment of the present invention, the physical format information (PFI) includes OPC target value information of the first waveform and the second waveform and recording waveform setting information of the first waveform as characteristics.

In FIGS. 7A and 7B, the application information starting from a byte position 512 and a part or all of the recording waveform setting information are the same information as land pre-pit information.

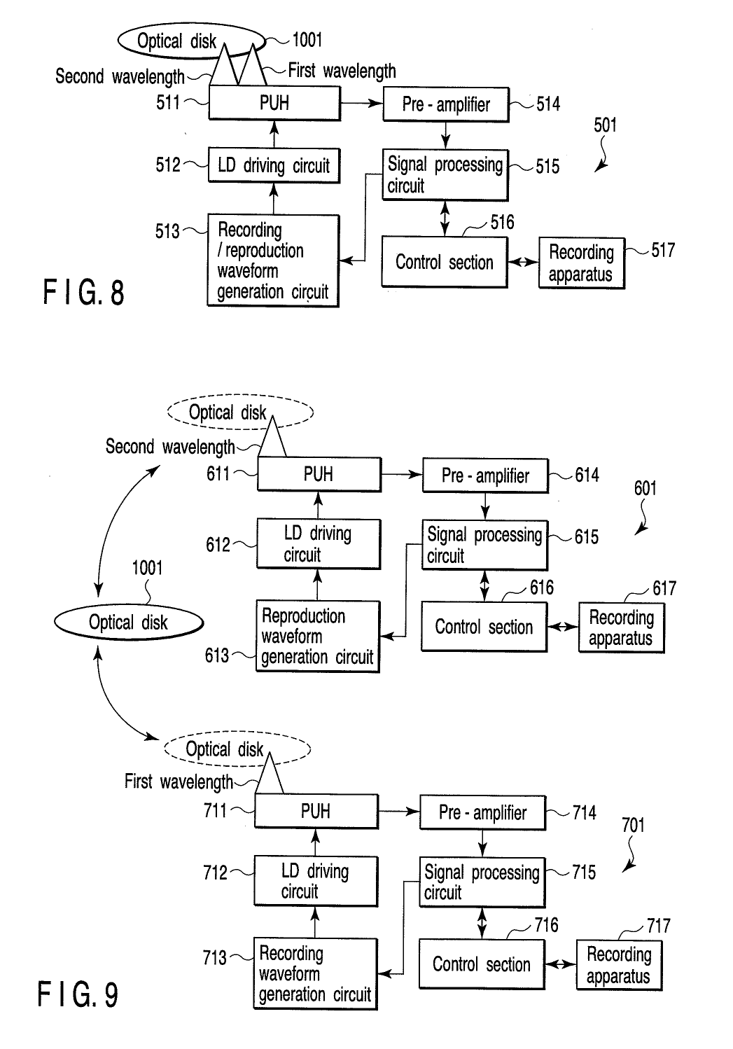

FIG. 8 is a function block diagram of the optical disc apparatus as an embodiment according to the present invention.

The optical disc apparatus 501 depicted in FIG. 8 is an apparatus into/from which information can be recorded/reproduced.

The optical disc apparatus 501 condenses a laser beam with a predetermined wavelength emitted from a pickup head (PUH) 511, i.e., an optical head, on the information recording layer of the optical disc 1001, thereby recording/reproducing information.

The light reflected from the optical disc 1001 again passes through an optical system of the PUH 511 to be detected as an electric signal by a photodetector provided in the system.

The detected electric signal is amplified by a pre-amplifier 514 to be output to a signal processing circuit 515 including a servo circuit, an RF signal processing circuit, an address signal processing circuit, and others although these circuits are not depicted.

The servo circuit generates, e.g., a focus, tracking, or tilt servo signal, and each signal is output to a non-illustrated focus, tracking, or tilt actuator of the PUH 511.

The RF signal processing circuit mainly processes a sum signal in detected signals, thereby reproducing information, e.g., recorded user information. At this time, as a demodulation method, there is, e.g., a (level) slicing mode or a Partial Response Maximum Likelihood (PRML) mode. It is to be noted that, when using the PRML mode, an error correction technology at the time of ML demodulation is also used.

The address signal processing circuit processes each detected signal to read physical address information indicative of a recorded position in the optical disc 1001, and outputs the read information to a control section 516.

The control section 516 reads out information, e.g., user information at a desired position based on this address information, or records information, e.g., the user information at a desired position. It is to be noted that the user information is modulated into data suitable for optical disc recording by a recording signal processing circuit at this moment.

For modulation of data, a modulation mode, e.g., (2, 10) RLL modulation or (1, 10) RLL modulation is used. In the (2, 10) RLL modulation, the shortest code and the longest code used to modulate data are 3T and 11T, respectively. Further, a code 14T that is not present in a modulation rule is added for synchronization detection. Here, T represents a reference channel clock interval.

A recording/reproducing waveform generation circuit 513 generates a signal that controls a laser emission waveform based on an input code. Based on this output signal, an LD driving circuit 512 drives a laser element, which is not explained in detail, of the PUH 511 so that a laser beam with the first wavelength or the second wavelength having a predetermined intensity is emitted, thereby recording information in the optical disc 1001/reproducing information from the optical disc 1001.

Furthermore, the PUH 511 of the optical disc apparatus 501 according to the present invention has a function enabling application of laser beams having the two wavelengths, i.e., the first and second wavelengths. It is to be noted that the explanation will proceed on the assumption that the first wavelength is 405 nm and the second wavelength is 650 nm.

When recording data, an LD that can emit a laser beam having the first wavelength through the recording/reproducing waveform generation circuit is driven to perform recording. Moreover, light returning from the optical disc is used to detect a characteristics amount for OPC, detect a wobble signal, and detect a land pre-pit signal.

When reading data, an LD that can emit a laser beam having the second wavelength through the recording waveform generation circuit is driven to reproduce a signal. At this time, light returning from the optical disc is used to detect a characteristic amount for OPC, measure signal grade information, and read recorded data.

The control section 516 can determine a later-explained OPC target value, calculate the signal grade information, and determine an optimum recording waveform shape. The grade information of a signal is information, e.g., an error rate as a reading ratio of read data, the number of parity errors that enables estimating an error rate, or jitter.

FIG. 9 shows another embodiment of the optical disc according to an embodiment of the present invention.

In this embodiment, the optical disc apparatus is divided into a read-only apparatus 601 and a recording-only apparatus 701. The read-only apparatus 601 has an LD that can emit a laser beam having the second wavelength, and can detect a characteristic amount for OPC, measure signal grade information, and read recorded data. On the other hand, the recording-only apparatus 701 has an LD that can emit a laser beam having the first wavelength, and can record data. Moreover, light returning from the optical disc can be used to detect a characteristic amount for OPC, detect a wobble signal, and detect a land pre-pit signal.

In the system according to this embodiment, the optical disc 1001 is carried between the recording-only apparatus and the read-only apparatus at the time of recording and reproducing data.

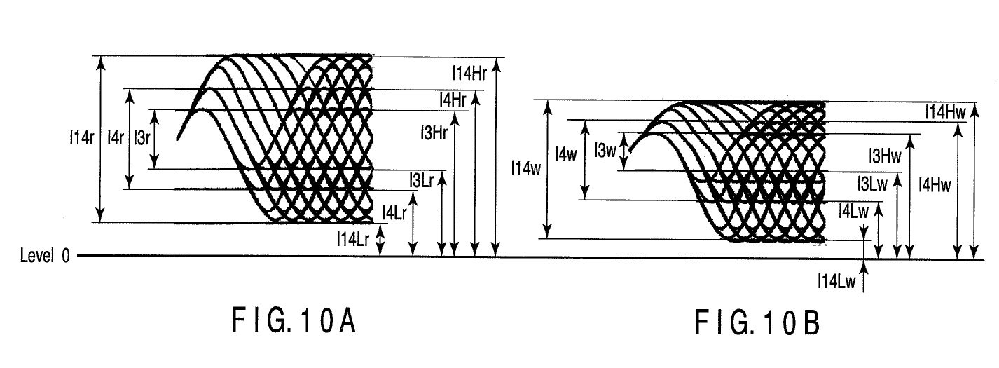

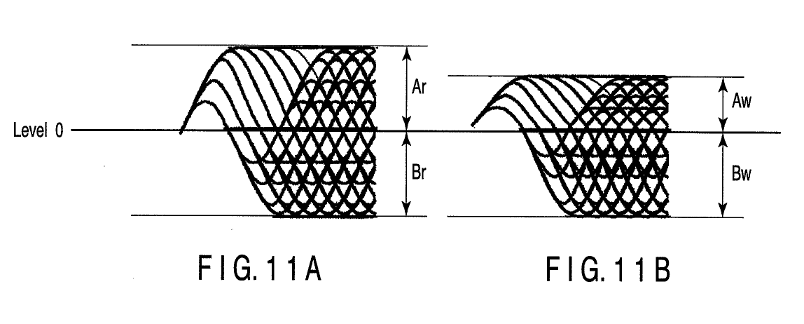

FIGS. 10A and 10B and FIGS. 11A and 11B show eye patterns of a reproducing waveform for recorded data. FIGS. 10A and 10B show direct output of the reproducing waveform, and FIGS. 11A and 11B show output in a state where the reproducing waveform is AC-coupled. A 0 level in the drawings represents an output level in a state where information in the optical disc is not reproduced.

FIG. 10A shows an eye pattern when recorded data is reproduced by using a laser with the second waveform. Data from 3T to 14T is recorded in the optical disc. Since data having the largest signal amplitude is 14T, a signal produced at the lowest level and a signal produced at the highest level belong to this 14T signal.

Here, it is assumed that a signal at the lowest level obtained from 14T data is I14Lr and a signal at the high level obtained from the same is I14 Hr. Likewise, it is assumed that respective parts of a 3T signal are I3Lr and I3Hr and respective parts of a 4T signal are I4Lr and I4Hr. Additionally, amplitudes of signals obtained from respective pieces of T data are called I3r, I4r, . . . , and I14R.

FIG. 10B shows an eye pattern when recorded data is reproduced by using a laser beam having the first wavelength. Since a size of a spot condensed on the optical disc, a light diffraction state, characteristics of a detection system, and others are different from those in the example where the laser beam having the second wavelength depicted in FIG. 10A is applied, a shape of the reproduction signal differs when the first laser beam is applied.

An entire signal level of the waveform depicted in FIG. 10B is lower than that of the waveform depicted in FIG. 10A, and a level of 3T data is relatively higher than a level of 14T data. Here, respective T levels when data is reproduced by using the first laser are called I3Lw, I3Hw, I4Lw, I4Hw, I14Lw, and I14Hw, and amplitudes in the same situation are called I3w, I4w, . . . , and I14w.

A characteristic amount concerning a recording waveform will now be explained.

Optimization of a recording waveform according to an embodiment of the present invention is calculating a waveform characteristic amount from a reproducing waveform and evaluating this characteristic amount to determine an optimum shape of the recording waveform. As the characteristic amount used in an embodiment according to the present invention, there is, e.g., an asymmetry, a modulation degree, a 3T4T asymmetry, an asymmetry variation, or a modulation degree variation.

The asymmetry is an index that is used to evaluate whether central levels of respective T signals are the same level. The asymmetry (w) of a signal reproduced by using the laser having the first wavelength is represented by the following expression (1).

Asymmetry(w)=[(I14Hw+I14Lw)−(I3Hw+I3Lw)]/[2×(I14Hw−I14Lw)] (1).

Further, an asymmetry (r) of a signal reproduced by using the laser beam having the second wavelength is represented by the following expression (2).

Asymmetry(r)=[(I14Hr+I14Lr)−(I3Hr+I3Lr)]/[2×(I14Hr−I14Lr)] (2).

When this is adapted to, e.g., the reproducing waveforms depicted in FIGS. 10A and 10B, in the waveform depicted in FIG. 10A, since the center of the level of the reproduction signal for the 14T data is substantially equal to the center of the level of the 3T signal, the asymmetry (r) is a value close to 0. On the other hand, in the waveform depicted in FIG. 10B, since the level of the 3T data is relatively higher than the level of the 14T data, the asymmetry (w) is a negative value. In this manner, the characteristic amount that is the asymmetry can be used to evaluate a shape of the reproduction signal.

Still another embodiment that evaluates the asymmetry (“β” is added to be discriminated from Expressions (1) and (2)) will now be explained.

FIG. 11B shows an output waveform when the reproduction signal that is used to reproduce recorded data by using the laser beam having the first waveform is AC-coupled. Here, assuming that a difference between a level at a maximum value part of the signal and the 0 level is Aw and a difference between a level at a minimum value part of the signal and the 0 level is Bw, an asymmetry (βw) calculated from this signal can be represented by the following expression (3).

βw=(Aw+Bw)/(Aw−Bw) (3).

Likewise, FIG. 11A shows an output waveform when the reproduction signal that is used to reproduce recorded data by using the laser beam having the first wavelength is AC-coupled. Here, assuming that a difference between a level at a maximum value part of the signal and the 0 level is Ar and a difference between a level at a minimum value part of the signal and the 0 level is Br, an asymmetry (βr) calculated from this signal can be represented by the following expression (4).

βr=(Ar+Br)/(Ar−Br) (4).

In FIG. 11A, since the waveform is symmetrical on upper and lower parts of the signal, a width of the upper part (Ar) and a width of the lower part (Br) of the 0 level are substantially the same when AC coupling is performed, and a result of Expression (4) becomes substantially 0. On the other hand, in FIG. 11B, since the waveform is asymmetrical on upper and lower parts of the signal, a width of the upper part (Aw) and a width of the lower part (Bw) of the 0 level are different from each other when AC coupling is carried out, and a result of Expression (3) becomes a negative value. In this manner, the asymmetry can be likewise evaluated when β(w) or β(r) is used.

The modulation degree (m) is an index that is used to evaluate an amplitude of a signal.

The modulation degree m(w) of a signal reproduced by using the laser beam having the first wavelength can be represented by the following expression (5).

m(w)=[I14w/I14Hw] (5).

The modulation degree m(r) of a signal reproduced by using the laser beam having the second wavelength can be represented by the following expression (6).

m(r)=[I14r/I14Hr] (6).

The 3T4T asymmetry is an index that is used to evaluate whether a central level of the 3T signal is the same as a central level of the 4T signal. The 3T4T asymmetry (w) of a signal reproduced by using the laser beam having the first wavelength can be represented by the following expression (7).

3T4T asymmetry(w)=[(I4Hw+I4Lw)−(I3Hw+I3Lw)]/[2×(I14Hw−I14Lw)] (7).

Further, the 3T4T asymmetry (r) of a signal reproduced by using the laser beam having the second wavelength can be represented by the following expression (8).

3T4T asymmetry(r)=[(I4Hr+I4Lr)−(I3Hr+I3Lr)]/[2×(I14Hr−I14Lr)] (8).

The asymmetry variation (X) is a value that evaluates a variation in an asymmetry with respect to a change in a recording waveform setting.

For example, assuming that an asymmetry N(w) is an asymmetry of a signal reproduced by using the laser beam having the first wavelength when recording data with a recording power N [mW] and an asymmetry M(w) is an asymmetry of a signal reproduced by using the laser beam having the first wavelength when recording data with a recording power M [mW], an asymmetry variation (w) measured by the laser beam having the first wavelength can be represented by the following expression (9).

Asymmetry variation X(w)=(Asymmetry M(w)−Asymmetry N(w))/(M−N) (9).

Likewise, an asymmetry variation (r) measured by the laser beam having the second wavelength can be represented by the following expression (10).

Asymmetry variation X(r)=(Asymmetry M(r)−Asymmetry N(r))/(M−N) (10).

A variation of the modulation degree (the modulation degree variation Y) can be likewise evaluated.

Assuming that a modulation degree N(w) is a modulation degree of a signal reproduced by the laser beam having the first wavelength when recording data with a recording power N [mW] and a modulation degree M(w) is a modulation degree of a signal reproduced by the laser beam having the first wavelength when recording data with a recording power M [mW], a modulation degree variation Y(w) measured by the laser beam having the first wavelength can be represented by, e.g., the following expression (11).

Modulation degree variation Y(w)=(Modulation degree M(w)−Modulation degree N(w)/(M−N) (11).

Furthermore, to fix a value of the modulation degree variation with respect to a difference between the recording powers as much as possible, a modulation degree variation γw represented by the following expression (12) can be used.

γw=[(Modulation degree M(w)−Modulation degree N(w))/(M−N)]×[M/Modulation degree M(w)] (12).

Likewise, a modulation degree variation γr measured by the laser beam having the second wavelength can be represented by the following expression (13).

γr=[(Modulation degree M(r)−Modulation degree N(r))/(M−N)]×[M/Modulation degree M(r)] (13).

In the present invention, using such a characteristic amount enables evaluating a state of accurately recorded data.

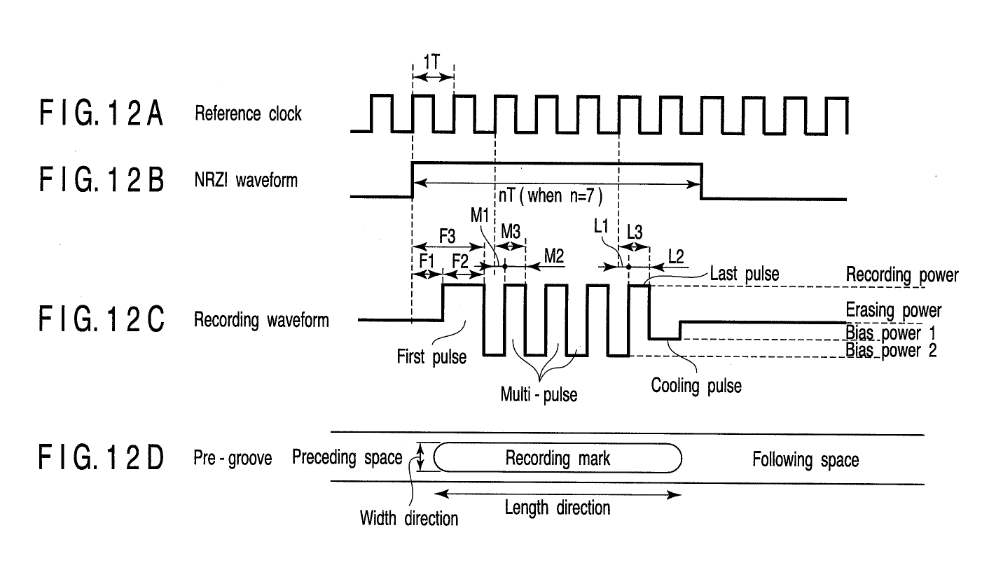

A method of setting a recording waveform by the optical disc apparatus according to an embodiment of the present invention will now be explained with reference to FIGS. 12A to 12D.

FIG. 12A is a schematic view of a signal of a clock serving as a reference used by the optical disc apparatus. Moreover, FIG. 12B shows recorded data converted into an NRZI (Non Return to Zero Invert, a method of matching a position of “1” to an edge portion/boundary portion of the recording mark or the pit) format. FIG. 12C shows a shape of a recording waveform. FIG. 12D is a schematic view showing a shape of the recording mark recorded on the pre-groove. Here, the recording waveform is set to use a plurality of pulses in order to record one mark.

Of the plurality of pulses, one placed at the head is called a first pulse, one placed at the end is called a last pulse, and those placed between the first and last pulses are called multi-pulses. Additionally, a part that outputs a bias power 1 (a cooling pulse) is also provided at the rear of the last pulse.

A shape of the recording waveform is defined in directions of four levels corresponding to a recording power, erasing power, a bias power 1, and a bias power 2. Likewise, a rising edge of data in the NRZI format and a clock signal are determined as references, and the recording waveform is defined in a time direction based on time information, e.g., a start time F1 (longer than 1T) of the first pulse, an end time F3 of the first pulse, and an interval F2 of the first pulse. Further, in regard to parameters that are apt affect formation of the recording mark, e.g., the start time F1 of the first pulse or an end time L3 (shorter than 1T) of the last pulse, each interval is dynamically changed during recording in accordance with a pattern of an NRZI signal. Such information is managed in a memory, which is not explained in detail, in the optical disc apparatus and also stored in the information recording medium as the format information depicted in FIG. 6 or FIGS. 7A and 7B.

A procedure of determining the recording waveform setting information based on the first wavelength stored in such an information recording medium as depicted in FIG. 6 or FIGS. 7A and 7B will now be explained.

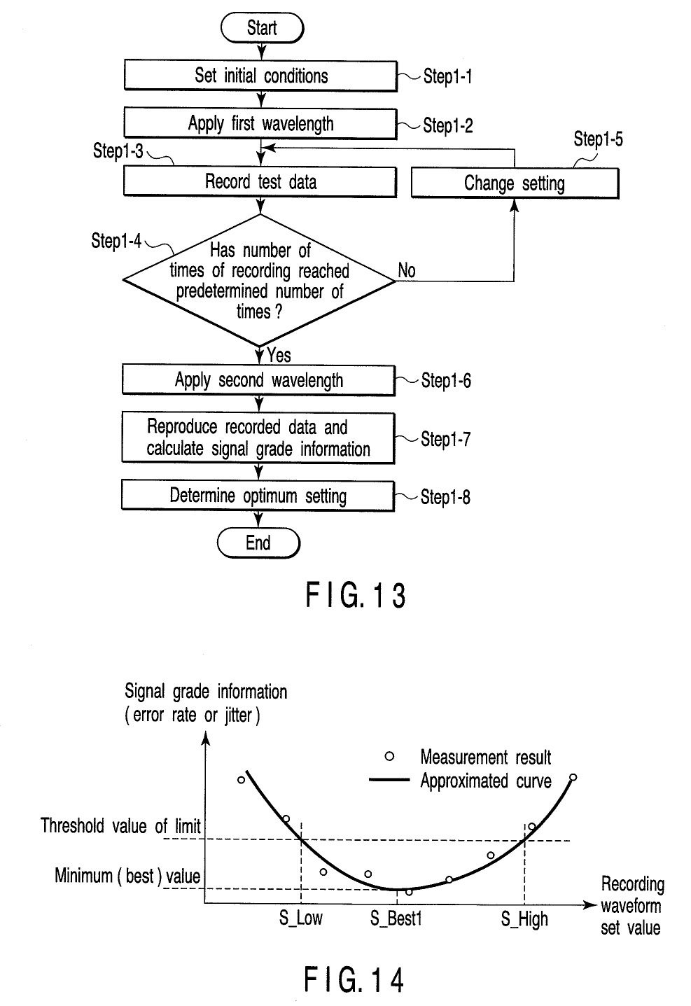

FIG. 13 shows a flow of determining the recording waveform setting information.

At a first step (Step 1-1), initial conditions of the optical disc apparatus are set. This is, e.g., conditions of a tracking servo or a focus servo or initial conditions of the recording waveform setting information. These conditions are determined based on physical characteristics or a past experience of the information recording medium whose optimum recording waveform setting information is to be determined or recommended data from a manufacturer.

At a second step (Step 1-2), the information recording medium is irradiated with the laser beam having the first wavelength, and a focus servo or a tracking servo is driven so that test data can be recorded.

At a third step (Step 1-3), the test data is recorded in the information recording medium by using the set recording waveform.

At a fourth step (Step 1-4), whether the number of times of recording the test data has reached a predetermined number of times is judged. The processing advances to a sixth step (Step 1-6) if the predetermined number of times has been reached, and the processing proceeds to a fifth step (Step 1-5) if the predetermined number of times has not been reached.

At the fifth step (Step 1-5), a set value of the recording waveform, e.g., the recording power is changed one step. When the fifth step is completed, the third step is again carried out to record the test data.

At the sixth step (Step 1-6), the wavelength of the laser beam applied to the information recording medium is changed from the first wavelength to the second wavelength so that information recorded in the information recording medium can be reproduced with the second wavelength. Here, in case of such an apparatus capable of performing recording and reproduction as shown in FIG. 8, changing the wavelength of the laser beam emitted from the PUH 511 by the control section 516 can suffice. When the reproduction apparatus and the recording apparatus are independently provided as shown in FIG. 9, the optical disc 1001 is carried between these apparatuses.

At a seventh step (Step 1-7), the recorded data recorded at the third step is reproduced, namely, the recorded data is reproduced and signal grade information is acquired (calculated). This reproduction is executed at each stage where setting and changing are carried out at the fifth step, and the signal grade information is calculated with respect to the recorded data at each stage. Here, the signal grade information is information, e.g., an error rate indicative of a reading ratio of the recorded test data, the number of parity errors that enables estimating an error rate, or jitter. FIG. 14 shows a graph obtained by plotting results measured at the seventh step.

At an eighth step (Step 1-8), an optimum set value of the recording waveform is determined based on the signal grade information calculated at the seventh step. The optimum setting can be determined by reading a recording waveform set value placed at a position having the most excellent signal grade information from an approximated curve of measured data as shown in FIG. 14. Here, since the grade of the signal is good when a value of an index, e.g., an error rate or jitter is small, a set value of the recording waveform providing the minimum index is the optimum set value (S_Best1).

Furthermore, when increasing robust properties of the set recording waveform is desired, a threshold value of a limit of the signal grade information is determined, a low recording waveform set value (S_Low) and a high recording waveform set value (S_High) are read with the threshold value at the center, and an optimum set value (S_Bset2) is determined based on the following expression (14).

S_Best2=(S_Low+S_High)/2 (14).

A manufacturer of the information recording medium uses this optimum set value determining method with respect to the recording waveform set value, e.g., the recording power, the erasing power, the start time of the first pulse, or the interval of the multi-pulses to determine an optimum value, and stores this value in the information recording medium by such a method as depicted in FIG. 6 or 7.

Moreover, a manufacturer of the optical disc apparatus (a disc drive) or a manufacturer of writing software uses the above-explained determining method to inimitably evaluate the information recording medium, determines the recording waveform set value optimum for each optical disc apparatus, and stores this value in a memory of the drive. In this example, at a first step, a recording waveform set value stored in the information recording medium and recommended by the manufacturer is utilized as initial conditions. This processing may be executed before shipment of the optical disc apparatus, or the optical disc apparatus can automatically execute this processing as an OPC operation before recording user data in the information recording medium.

A procedure of determining an OPC target value will now be explained.

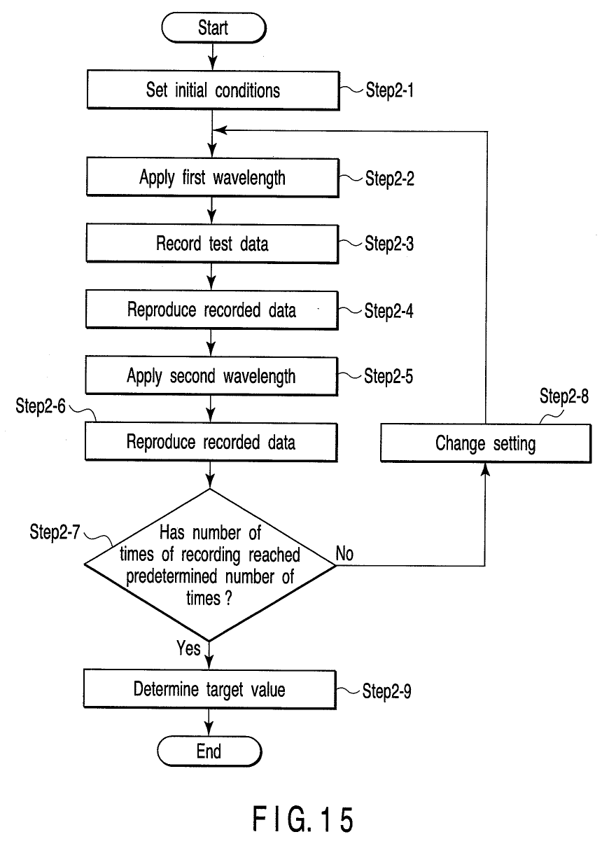

FIG. 15 shows a flow of determining an OPC target value.

At a first step (Step 2-1), initial conditions of the optical disc apparatus are set. This is, e.g., conditions of a tracking servo or a focus servo or initial conditions of recording waveform setting information. These conditions are determined from, e.g., physical characteristics or a past experience of the information recording medium whose optimum recording waveform setting information is to be determined or recommended data from a manufacturer.

Moreover, when an optimum recording waveform set value has been already determined or it is stored in the information recording medium, this information is used. At this time, when the initial conditions are set to a value that is smaller than an optimum value by a predetermined amount, the set value can be changed to be increased at a subsequent step so that a characteristic amount with respect to each set value or signal grade information can be measured.

Additionally, at the first step, a ratio of the recording power, the erasing power, and the bias powers 1 and 2 can be calculated from this recording waveform set value.

At a second step (Step 2-2), the information recording medium is irradiated with the laser beam having the first wavelength, and a focus or tracking servo is driven so that test data can be recorded.

At a third step (Step 2-3), the test data is recorded in the information recording medium by using the set recording waveform.

At a fourth step (Step 2-4), the test data recorded at the third step is reproduced by using the first wavelength to calculate a characteristic amount of a reproduction signal. Here, the characteristic amount is an amount, e.g., the asymmetry or the modulation degree.

At a fifth step (Step 2-5), the wavelength of the laser beam applied to the information recording medium is changed from the first wavelength to the second wavelength so that information recorded in the information recording medium can be reproduced by using the second wavelength. Here, in case of such an apparatus that can perform recording and reproduction as shown in FIG. 8, changing the wavelength of the laser beam emitted from the PUH 511 by the control section 516 can suffice. When the reproduction apparatus and the recording apparatus are independently provided as shown in FIG. 9, the optical disc 1001 is carried between the apparatuses.

At a sixth step (Step 2-6), the test data recorded at the third step is reproduced by using the second wavelength to calculate a characteristic amount of the reproduction signal and signal grade information.

At a seventh step (Step 2-7), whether the number of times of recording the test data has reached a predetermined number of times is judged. If the predetermined number of times has been reached, the processing advances to a ninth step (Step 2-9). If the predetermined number of times has not been reached, the processing proceeds to an eighth step (Step 2-8).

At the eighth step (Step 2-8), the set value of the recording waveform, e.g., the recording power is changed one step. At this time, when the ratio of the respective powers calculated at the first step is fixed and the powers other than the recording power are simultaneously effected in conjunction with the recording power, the entire powers can be optimized at a time.

Upon completion of the eighth step, the processing returns to the second step to change the wavelength of the laser beam applied to the information recording medium from the second wavelength to the first wavelength.

At the ninth step (Step 2-9), a target value for OPC is determined from the characteristic amount of the reproduction signal and the signal grade information measured and calculated at the former steps.

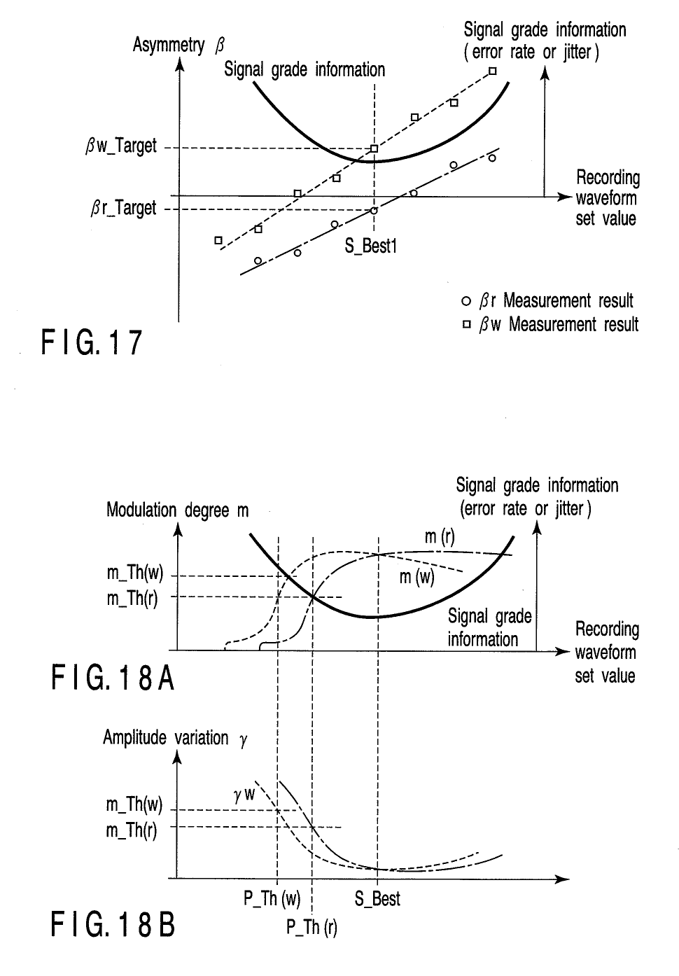

FIG. 17 shows a graph obtained by plotting results measured at the fourth step and the sixth step depicted in FIG. 15. FIG. 17 shows the asymmetry β, and the measured results are the asymmetry (βw) when the first wavelength is used to reproduce the recorded data, the asymmetry (βr) when the second wavelength is used to reproduce the recorded data, and the signal grade information. Further, FIG. 17 shows an approximated curve obtained from the measurement results of the asymmetry (βw) and the asymmetry (βr) and an approximated curve obtained from the measurement result of the signal grade information.

In FIG. 17, since a size or the like of a light spot condensed on the information recording medium varies depending on the first wavelength and the second wavelength, an inclination of the approximated curve of the asymmetry (βw) is different from that of the asymmetry (βr). Here, polarities of the inclinations of the asymmetry (βw) and the asymmetry (βr) may be opposite to each other depending on characteristics of the information recording medium.

At the ninth step, an optimum recording wavelength set value (S_Best) is determined from the measured signal grade information (the approximated curve depicted in FIG. 17). Furthermore, asymmetry (βw) under such conditions is read. This value is first wavelength OPC target information βw_Target (asymmetry βw). Likewise, a value of asymmetry (βr) under the conditions is read. This is second wavelength OPC target information βr_Target (asymmetry βr).

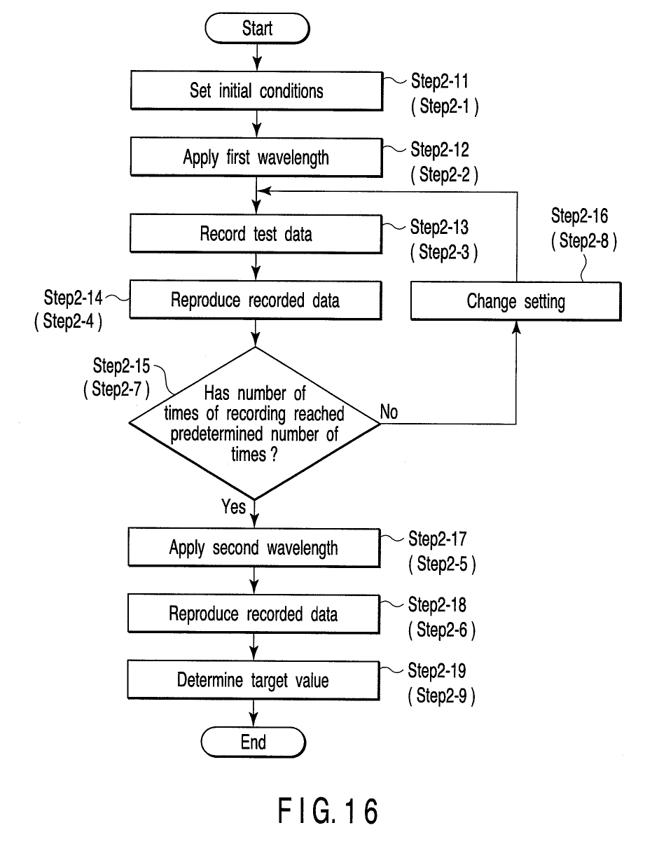

Furthermore, as shown in FIG. 16 illustrating a special example of the flow, when the optimum recording waveform set value has been already determined, an optimum value is set as a recording waveform at a first step (Step 2-11 [corresponding to Step 2-1 in FIG. 15]), a focus servo or a tracking servo is driven to record test data in the information recording medium at a second step (Step 2-12 [corresponding to Step 2-2 in FIG. 15]) and a third step (Step 2-13 [corresponding to Step 2-3 in FIG. 15]), the test data is reproduced by using the first waveform and a characteristic amount of a reproduction signal is calculated at a fourth step (Step 2-14 [corresponding to Step 2-4 in FIG. 15]), then whether the number of times of recording the test data has reached a predetermined number of time is judged at a fifth step (Step 2-15 [corresponding to Step 2-7 in FIG. 15]), and the processing may advance to a sixth step (Step 2-16 [corresponding to Step 2-5 in FIG. 15]) if the predetermined number of times has been reached, or the processing may proceed to a seventh step (Step 2-17 [corresponding to Step 2-8 in FIG. 15]) if the predetermined number of times has not been reached.

At the seventh step (Step 2-17), the set value of the recording waveform, e.g., the recording power is changed one step. At this time, when a ratio of the respective powers calculated at the first step is fixed and the powers other than the recording power are simultaneously effected in conjunction with the recording power, the entire powers can be optimized at a time. After completion of the seventh step, the processing returns to the third step to record the next test data in the information recording medium, the recorded data is reproduced at the fourth step, and the fifth step (a judgment upon the number of times) is executed.

At the sixth step (Step 2-16), a wavelength of the laser beam applied to the information recording medium is changed from the first wavelength to the second wavelength so that information recorded in the information recording medium can be reproduced by using the second wavelength. Here, in case of such an apparatus as shown in FIG. 8 that can perform recording and reproduction, changing the wavelength of the laser beam emitted from the PUH 511 by the control section 516 can suffice. When the reproduction apparatus and the recording apparatus are independently provided as shown in FIG. 9, the optical disc 1001 is carried between the apparatuses.

When the wavelength of the laser beam is changed to the second wavelength at the sixth step, the test data is reproduced to calculate a characteristic amount of a reproduction signal and signal grade information at an eighth step (Step 2-18 [corresponding to Step 2-8 in FIG. 15]).

At a ninth step (Step 2-19 [corresponding to Step 2-19 in FIG. 15]), a target value for OPC is determined from the measured and calculated characteristic amount of the reproduction signal and signal grade information.

In this case, at the ninth step, βw and βw measured only once become βw_Target and βr_Target, respectively.

FIGS. 18A and 18B show measurement results when a modulation degree m and a modulation degree variation γ are used for the characteristic amount as another embodiment. FIG. 18A shows approximated curves of measurement results of modulation degrees m(w) and m(r) and an approximated curve of a measurement result of the simultaneously measured signal grade information. On the other hand, FIG. 18B shows approximated curves of simultaneously measured modulation degree (amplitude) variations γ(w) and γ(r). When using the modulation degrees and the modulation degree variations for these characteristic amounts, an OPC target value is determined based on the following method.

First, a point having a large inclination of a change in the modulation degree m and a recording waveform set value P_Th(w) and a recording waveform set value P_Th(r) with which the modulation degree variation γ becomes predetermined values γ_Th(w) and γ_Th(r) are determined from the approximated curves of the characteristic amount measurement results obtained when using the first wavelength and the second wavelength.

Further, a modulation degree measured with the first wavelength when the recording waveform set value is P_Th(w) is determined as m_Th(w), and a modulation degree measured with the second wavelength when the recording waveform set value is P_Th(r) is determined as m_Th(r).

Furthermore, ratios Kw and Kr of the optimum recording waveform set value S_Best calculated from the approximated curve of the signal grade information and the recording waveform set values P_Th(w) and P_Th(r) are calculated based on the following expressions (15) and (16), respectively.

Kw=S_Best/P_{—}Th(w) (15).

Kr=S_Best/P_{—}Th(r) (16).

A part or all of the thus calculated and determined recording waveform set values P_Th(w) and P_Th(r), the ratios Kw and Kr of the recording waveform set values, the modulation degrees m_Th(w) and P_Th(r), and the modulation variations γ_Th(w) and γ_Th(r) can be used as OPC target information.

Moreover, although the procedure of determining the OPC target information has been explained with reference to the flowchart of FIG. 15, the OPC target information can be likewise determined even if the order of the respective steps is counterchanged like the flow depicted in FIG. 16 as explained above. However, in case of the flow depicted in FIG. 16, reproduction of the recorded data and calculation of the characteristic amount and the signal grade information at the eighth step (Step 2-18 [corresponding to Step 2-6 in FIG. 15]) are carried out at each step where setting and changing are executed at the seventh step (Step 2-16 [corresponding to Step 2-8 in FIG. 15]). That is, the characteristic amount and the signal grade information obtained at the eighth step are acquired with respect to the recorded data in a plurality of stages.

A manufacturer of the information recording medium stores a value of the determined OPC target information in the information recording medium by using such a method as shown in FIG. 6 or FIGS. 7A and 7B.

Additionally, an optical disc apparatus manufacturer or a writing software manufacturer uses the above-explained determination method to inimitably evaluate the information recording medium, determines OPC target information optimum for each optical disc apparatus, and stores the determined information in a memory of a drive. This processing may be executed before shipment of the optical disc apparatus, or the optical disc apparatus may automatically execute this processing before recording user data in the information recording medium in order to determine an OPC target value used for later-explained ROPC that is a part of an OPC operation.

A procedure of recording information in the information recording medium executed by the optical disc apparatus and a procedure of automatically optimizing a recording waveform executed in conjunction with the former procedure according to an embodiment of the present invention will now be explained.

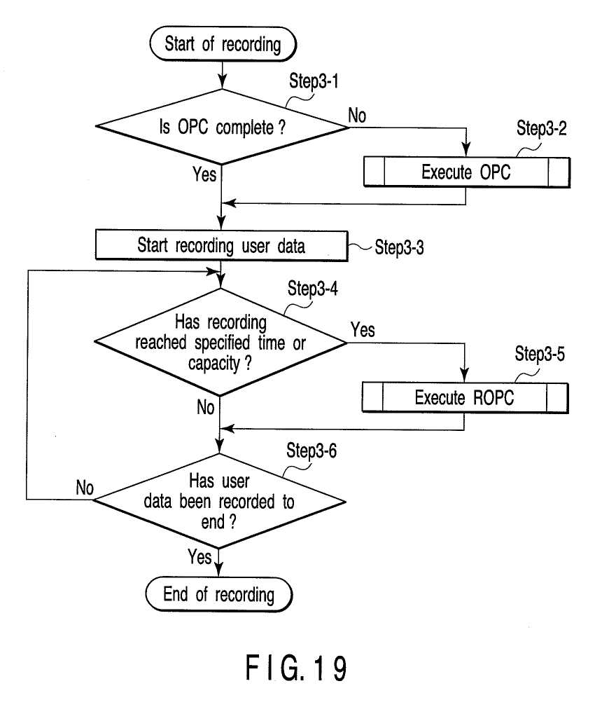

FIG. 19 shows a flow of recording information executed by the optical disc apparatus.

At a first step (Step 3-1), the optical disc apparatus judges whether optimization (OPC) of a recording waveform has been completed with respect to the information recording medium in which information is to be recorded.

If OPC has been completed, the processing advances to a third step (Step 3-3), and the optimum recording waveform determined by the OPC operation is used to record information, e.g., user data in the information recording medium. When OPC is not executed or when a time has passed from execution of OPC and up-to-date information is not present, the processing advances to a second step (Step 3-2) to carry out OPC. When OPC is completed, the processing proceeds to a third step. The detailed procedure of OPC will be explained later.

At a fourth step (Step 3-4), whether a predetermined time has passed after start of recording the information or whether a predetermined capacity has been reached is judged. If it is determined that recording has been performed for the predetermined time or for the predetermined capacity, the processing advances to a fifth step (Step 3-5). If it is determined that the recording has not been performed for the predetermined time or for the predetermined capacity, the processing proceeds to a sixth step (Step 3-6).

At the fifth step, an operation of optimizing the recording waveform during recording information, e.g., user data is carried out. This is an operation called Runing Optimum Power Control (ROPC) or Stop and Optimum Power Control (SOPC).

At the sixth step (Step 3-6), whether the information, e.g., user data has been recorded to the end is judged. If recording is completed, the processing is terminated. If recording is not completed, the processing returns to the fourth step.

In this manner, according to the recording procedure of this embodiment, OPC is executed before recording the information, e.g., user data, and the ROPC operation is appropriately performed during recording the information.

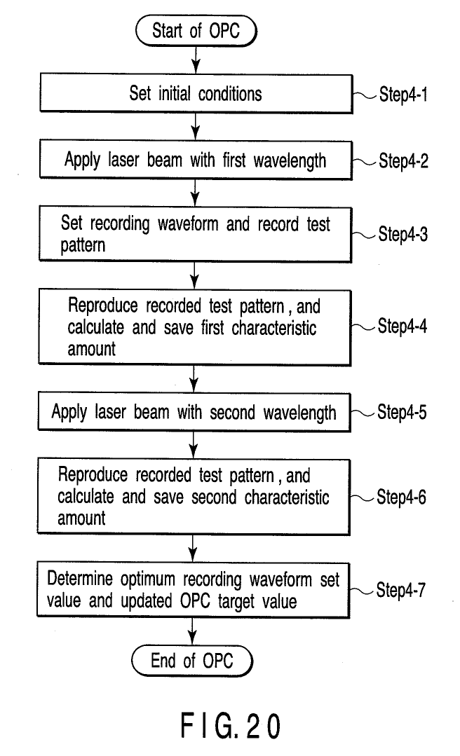

FIG. 20 shows a flow of an OPC operation. A description will be first given on an example where the optical disc apparatus can apply laser beams having both the first wavelength and the second wavelength as shown in FIG. 8.

In the OPC operation according to this embodiment, initial conditions are set at a first step (Step 4-1). As the initial conditions for a recording waveform set value and an OPC target value, land pre-pit information of the information recording medium or set values read from physical format information are used, or a recording waveform set value and an OPC target value stored in a memory of the optical disc apparatus are used when information that coincides with a disc ID read from the optical disc is present in the memory of the optical disc apparatus. Here, the laser beam having the first wavelength is used when reading the land pre-pit information, and the laser beam having the second wavelength is used when reading the physical format information in a control region.

At a second step (Step 4-2), a laser beam applied to the information recording medium is set to the laser beam having the first wavelength.

At the third step (Step 4-3), focusing on the initial conditions set at the first step (or read from the memory), a predetermined amount of test data is recorded in a test region of the information recording medium while changing the setting of the recording waveform in a plurality of stages.

At a fourth step (Step 4-4), the recorded test data having the recording waveform setting changed at the third step is reproduced in stages, and it is stored in the memory of the optical disc apparatus as a first characteristic amount. At this time, a set value of the recording waveform in each stage is also stored.

Subsequently, at a fifth step (Step 4-5), the laser beam applied to the information recording medium is changed to the laser beam having the second wavelength.

At a sixth step (Step 4-6), the test data recorded at the third step is reproduced in accordance with each of the stages where the recording waveform setting is changed, and it is stored in the memory of the optical disc apparatus as a second characteristic amount.

At a seventh step (Step 4-7), the initial conditions for the OPC target value set at the first step (or read from the memory) are compared with the first characteristic amount or the second characteristic amount corresponding to the set value of the recording waveform in each of the plurality of stages stored at the fourth step or the sixth step. Further, a stage where the target value and the characteristic amount coincide with each other or where they are close to each other at a maximum is retrieved, and this recording waveform set value in this stage is determined as an actual optimum recording waveform set value. Furthermore, the first characteristic amount or the second characteristic amount corresponding to the set value adopted as this actual optimum recording waveform setting is employed as an updated OPC target value. This updated OPC target value is used for the subsequent ROPC operation. Then, the OPC operation is completed.

When subsequently recording information, e.g., user data in the information recording medium, the actual optimum recording waveform set value determined here is used.

A detailed example of the flow will now be explained while giving a specific example of the characteristic amount with reference to FIG. 20. Here, each of asymmetries β(w) and β(r) is used as the characteristic amount, and a recording power Pp [mW] is used as the recording waveform set value that is changed at the third step (Step 4-3).

First, a second wavelength OPC target value, i.e., an asymmetry βr_Target read from the information recording medium is determined as an OPC target value at the first step (Step 4-1), and a recording power Pp is changed in eight stages from Pp(0) to Pp(7) to record test data at the second step (Step 4-2) and the third step (Step 4-3).

At the fourth step (Step 4-4), values of asymmetries βw(0) to βw(7) are stored as characteristic amounts corresponding to respective stages.

The laser beam having the second wavelength is applied at the fifth step (Step 4-5), and values of asymmetries βr(0) to βr(7) are acquired as characteristic amounts according to respective stages where reproduction is carried out by using the laser beam having the second wavelengths and they are stored in, e.g., a non-illustrated memory provided in the optical disc apparatus (drive) at the sixth step (Step 4-6).

At the seventh step (Step 4-7), the OPC target value βr_Target set at the beginning is compared with βr(0) to βr(7), and one that is closest to βr_Target is determined from βr(0) to βr(7).

Here, it is assumed that βr(3) is closest to βr_Target. In this case, Pp(3) associated with βr(3) is selected as an actual optimum recording waveform set value. Further, βw(3) is selected as an updated OPC target value for the laser beam having the first wavelength. To further increase an accuracy, respective measurement results may be subjected to linear interpolation to determine a value. For example, when βr_Target coincides with (3×βr(2)+2×βr(3))/5, (3×Pp(2)+2×Pp(3))/5 is selected as an actual optimum recording waveform set value, and (3×βw(2)+2×βw(3))/5 is selected as an updated OPC target value βw_NewT.

An example where a plurality of types of characteristic amounts are used as a first characteristic amount and a second characteristic amount will now be explained.

Here, an asymmetry βw and a modulation degree variation γr are used as characteristic amounts, and a recording power Pp [mW] is used as a recording waveform set value that is changed at the third step. First, a second wavelength OPC target value and a modulation degree variation γr_Target read from the information recording medium are determined as OPC target values at the first step.

Furthermore, a ratio Kr is read from the information recording medium.

As explained above, test data is recorded while changing the recording power Pp in eight stages from Pp(0) to Pp(7) at the third step, and values of the asymmetries βw(0) to βw(7) are stored as characteristic amounts corresponding to the respective stages that are data reproduced at the fourth step.

At the sixth step, values of the modulation degree variations γr(0) to γr(7) are stored as characteristic amounts corresponding to the respective stages.

At the seventh step, the OPC target value γr_Target set at the beginning is compared with γr(0) to γr(7), and one that is closest to γr_Target is determined from γr(0) to γr(7). Here, it is assumed that γr(3) is closest to γr_Target. In this case, Pp(3)×Kr obtained by multiplying Pp(3) associated with γr(3) by a ratio Kr is selected as an actual optimum recording wave set value.

Moreover, one that is closest to Pp(3)×Kr is selected from γr(0) to γr(7). Here, when Pp(6) associated with the sixth stage is the closest value, βw(6) likewise associated with the sixth stage is selected as an updated OPC target value for the laser beam having the first wavelength.

An ROPC operation will now be explained.

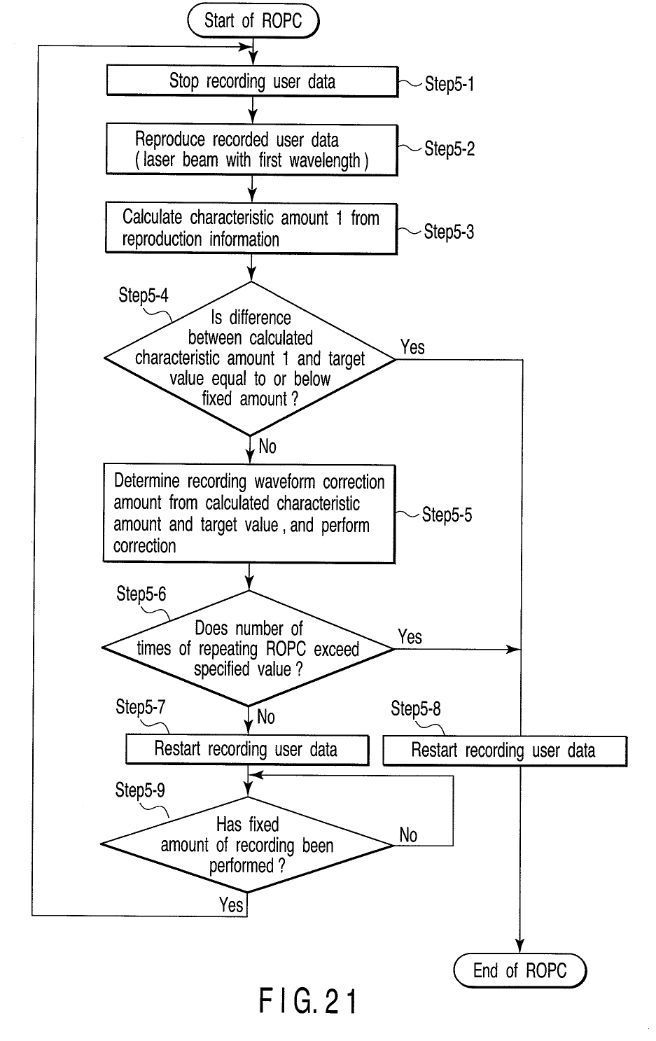

FIG. 21 shows a flow of the ROPC operation.

At a first step (Step 5-1), recording user data is first stopped.

At a second step (Step 5-2), the previously recorded user data is reproduced. At this time, since the laser beam applied to the information recording medium is not changed, the first wavelength for recording is used to perform reproduction.

At a third step (Step 5-3), a first characteristic amount is calculated from a reproduced signal.

At a fourth step (Step 5-4), the first characteristic amount calculated at the third step is compared with a previously set OPC target value or an updated OPC target value to judge whether a difference between these values is equal to or below a predetermined amount.

If the difference is equal to or below the predetermined amount, the ROPC is terminated, and the processing advances to restart recording the user data in an eighth step (Step 5-8).

If the difference is larger than the predetermined amount, the processing advances to a fifth step (Step 5-5).

At the fifth step, the difference between the first characteristic amount calculated at the third step and the previously set OPC target value or the updated OPC target value is used to determine a correction amount of a setting of a recording waveform, and the setting of the recording waveform is changed in accordance with the determined correction amount.

At the sixth step (Step 5-6), the number of times of repeating the first step to the fifth step is calculated. If the number of times of repetition exceeds a predetermined number, the processing proceeds to the eighth step (Step 5-8), and the ROPC is terminated. If the number of times of repetition is not greater than the predetermined number, the processing advances to a seventh step (Step 5-7).

At the seventh step, recording the user data in the information recording medium is restarted. At a ninth step (Step 5-9), whether recording of the user data restarted at the seventh step has been performed for a predetermined amount is judged.

That is, recording has been carried out for the predetermined amount, the processing proceeds to the first step. When the predetermined amount is not reached, recording of the user data is continuously performed.

A detailed example of the flow will now be explained while giving a specific example of the characteristic amount. Here, an asymmetry βw is used as a characteristic amount, and a recording power Pp [mW] is used as a recording waveform set value corrected at the sixth step.

At the third step, βw(U) is calculated as a first characteristic amount.

Moreover, at the fourth step, βw_NewT determined by the OPC operation is used as a value that is utilized for comparison at the fourth step. Here, if βw(U) is smaller than βw_NewT by a predetermined amount, the recording power Pp is corrected to a one step higher power at the sixth step when a relationship between β and the recording power Pp [mW] as a characteristic of the information recording medium is such a relationship as shown in, e.g., FIG. 17.

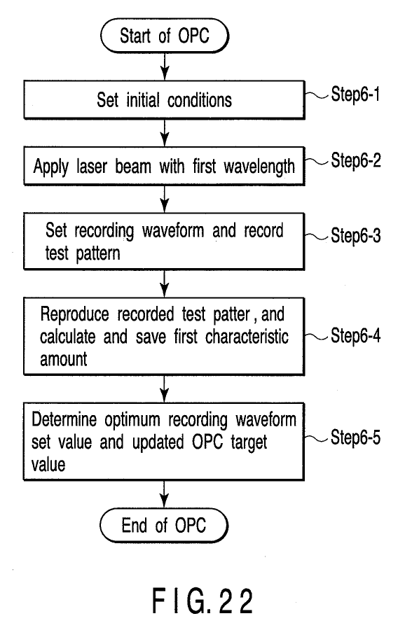

An OPC operation in such a recording-only apparatus as shown in FIG. 9 that can emit a laser beam having the first wavelength only will now be explained with reference to FIG. 22.

Initial conditions are set at a first step (Step 6-1). As the initial conditions for a recording waveform set value and an OPC target value, land pre-pit information of the information recording medium or set values red from physical format information are utilized, or a recording waveform set value and an OPC target value stored in a memory in the optical disc apparatus are used when information that coincides with a disc ID read from the disc is present in the memory in the optical disc apparatus.

At a second step (Step 6-2), a laser beam applied to the information recording medium is set to a laser beam having the first wavelength.

At a third step (Step 6-3), focusing on the initial conditions set at the first step, a predetermined amount of test data is recorded in a test region of the information recording medium while changing a setting of a recording waveform in a plurality of stages.

At a fourth step (Step 6-4), the recorded test data is reproduced in accordance with each of the stages where the setting of the recording waveform is changed at the third step, and it is stored in the memory in the optical disc apparatus as a first characteristic amount. At this time, a set value of the recording waveform in each of the stages is also stored.

At a fifth step (Step 6-5), the initial conditions for the OPC target value set at the first step are compared with the first characteristic amount corresponding to the set value of the recording waveform in each of the plurality of stages. Moreover, a stage where the target value and the characteristic amount coincide with each other or they are close to each other at a maximum is retrieved, and a recording waveform set value in this stage is determined as an actual optimum recording waveform set value. Additionally, the first characteristic amount associated with the set value adopted as this actual optimum recording waveform setting is employed as an updated OPC target value.

This updated OPC target value is used in a subsequent ROPC operation. Then, the OPC operation is completed.

When subsequently recording information, e.g., user data in the information recording medium, the actual optimum recording waveform set value determined here is used. It is to be noted that the term “OPC” is often generally used in referring to power adjustment in a level direction, but it also includes adjustment in a time direction in this explanation.

As explained above, in the information recording medium according to the present invention, it is possible to optimize information recording conditions when information is written by using a laser beam having the first wavelength and the information is read by using a laser beam having a wavelength different from the former wavelength. That is, (test) information recorded in the information recording medium is reproduced by using laser beams having two types of wavelengths in advance, and characteristic amounts detected from reproduction signals in such reproduction are compared to determine a target value for recording condition optimization. When writing the information, reproduction is simultaneously performed by using a laser beam having a wavelength for a writing operation, and a reproduction signal and a target value are compared to enable optimizing the recording conditions. That is, information can be stably written in the single information recording medium in which the information is written by using a laser beam having one type of wavelength and the information is read by using a laser beam having a different type of wavelength.

Further, in the procedure according to the present invention, when reproduction of signals based on laser beams having two types of wavelengths, i.e., one wavelength used for recording and a different wavelength used for reproduction is carried out and a target value is determined before writing information, recording conditions can be optimized with information of the reproduction signal based on the one wavelength alone when writing the information.

Furthermore, when recording information in a recording medium by using a wavelength of a laser beam for recording and a different wavelength of a laser beam for reproduction, it is possible to greatly reduce a burden on the recording apparatus due to frequently changing the laser beams having the two types of wavelength or simultaneously applying these laser beams.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording medium configured to have information written to it using a laser beam having a first wavelength and information read from it using a laser beam having a second wavelength longer than that of the first laser beam, the recording medium comprising:
a recording layer configured to be recorded with information,
management information comprising a set of optimized parameters of recording conditions configured to be recorded with a previously formed mark in the recording layer, wherein the set of parameters comprises a value calculated from a signal waveform reproduced with the laser beam having the first wavelength, the reproduced signal configured to be recorded for optimized reproduction of the signal using the laser beam having the second wavelength.

2. A method of determining a target value for optimizing a recording signal when recording a signal in an information recording medium configured to record information written using a laser beam having a first wavelength and to be read using a laser beam having a second wavelength longer than that of the first laser beam, the method comprising:
recording a signal in the information recording medium with the laser beam having the first wavelength;
reproducing the signal recorded with the laser beam having the first wavelength and measuring a first evaluation amount used to calculate the target value for optimizing recording conditions;
reproducing a signal recorded with the laser beam having the second wavelength and measuring a second evaluation amount for optimizing a reproduced signal; and
comparing the first evaluation amount with the second evaluation amount to determine the first evaluation amount under the recording conditions where the second evaluation amount is optimized as the target value for optimizing the recording conditions.

3. An information recording apparatus configured to write information in a recording medium with a laser beam having a first wavelength and to read information from or write information in the recording medium with a laser beam having a second wavelength longer than that of the first laser beam, the apparatus comprising:
a laser beam emitting section configured to emit the laser beam having the first wavelength;
a laser beam receiving section configured to receive a return beam from the information recording medium;
a control section configured to control an emitted waveform of the laser beam having the first wavelength; and
an information storage section configured to hold a target value,
wherein the target value is determined from a relationship between an evaluation amount prepared in the information storage section in advance and used to perform reproduction with the laser beam having the second wavelength, and an evaluation amount calculated from a reproduced signal recorded with the laser beam having the first wavelength and reproduced with the laser beam having the first wavelength and used to change recording conditions so that a signal reproduced with the laser beam corresponds with the target value.

4. An information recording method, comprising:
using a target value, determined from a relationship between an evaluation amount calculated from a reproduced signal recorded with the laser beam having a first wavelength and reproduced with the laser beam having the first wavelength and an evaluation amount is prepared in advance and used to perform reproduction with the laser beam having the second wavelength,
carrying out recording of information and reproduction of a signal with respect to an information recording medium with the laser beam having the first wavelength, and
changing recording conditions of a rotation apparatus so that the reproduced signal corresponds with the target value so as rotate the recording medium at a predetermined rate.

5. The method of claim 2, wherein
recording condition learning data is recorded in the information recording medium with the laser beam having the first wavelength before writing the information;
the first evaluation amount calculated from a reproduced signal recorded with the laser beam having the first wavelength, and the second evaluation amount calculated from the reproduced signal with the laser beam having the second wavelength are configured to be measured;
the first evaluation amount is configured to be compared with the second evaluation amount to determine the first evaluation amount under the recording conditions where the second evaluation amount is configured to become optimum as the target value for optimizing the recording condition;
information is configured to be written by with the laser beam having the first wavelength while writing the information and the recorded signal is configured to be reproduced with the laser beam having the first wavelength; and
the first evaluation amount is configured to be calculated from a reproduced signal to change the recording conditions based on a comparison between the target value and the measured first evaluation amount.

6. The apparatus of claim 3, wherein the evaluation amount calculated from the reproduced signal recorded with the laser beam having the first wavelength and reproduced with the laser beam having the first wavelength, and the target value prepared in advance are configured to be used to perform recording of information and reproduction of a signal with respect to the information recording medium by using the laser beam having the first wavelength, and the recording conditions are configured to be changed so that the reproduced signal corresponds with the target value.

7. The apparatus of claim 3, wherein recording condition learning data is recorded in the information recording medium with the laser beam having the first wavelength before writing information;
a first evaluation amount calculated from a reproduced signal recorded with the laser beam having the first wavelength and a second evaluation amount calculated from a reproduced signal with the laser beam having the second wavelength are measured;
the first evaluation amount is compared with the second evaluation amount, and the first evaluation amount under the recording conditions where the second evaluation amount becomes optimum is determined as the target value for optimizing the recording conditions;
information is written with the laser beam having the first wavelength while writing the information, and a recorded signal is reproduced with the laser beam having the first wavelength; and
the first evaluation amount is calculated from a reproduced signal, and the recording conditions are changed based on a comparison between the target value and the measured first evaluation amount.
